(19) United States
(12) Patent Application Publication
(10) Pub. No.: US 2008/0174723 A1
(43) Pub. Date: Jul. 24, 2008

(54) LIQUID CRYSTAL DISPLAY DEVICE AND MANUFACTURING METHOD THEREOF

(76) Inventors: Yasushi Sano, Yokohama (JP); Shinji Sekiguchi, Kawasaki (JP); Keiji Takanosu, Yokohama (JP); Koji Hara, Yokohama (JP); Hiroyasu Matsuura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/970,603

(22) Filed: Jan. 8, 2008

(30) Foreign Application Priority Data
Jan. 9, 2007 (JP) 2007-000963

(51) Int. Cl. G02F 1/1335

(52) U.S. Cl. 349/96; 349/117; 349/190

(57) ABSTRACT

In the present invention, to realize a liquid crystal display device of high-definition transflective IPS system comprising an inner retardation plate (retardation layer) in a reflective display unit, the retardation layer is formed of liquid crystal monomers with acrylates containing a polymerization initiator and either one or both of a triplet quencher and a radical quencher added.

The present application claims priority from Japanese application JP2007-000963 filed on Jan. 9, 2007, the content of which is hereby incorporated by reference into this application.

### BACKGROUND OF THE INVENTION

1. Field of the Invention

The invention relates to a liquid crystal display device, particularly to a liquid crystal display device which can made reflective display of images in a wide range of environment from a light place to a dark place and execute a transmissive display with a wide viewing angle and high picture quality, and to a method of manufacturing the same.

2. Description of the Related Art

At present, a transmissive liquid crystal display device with a wide viewing angle of an IPS (In Plane Switching) system, a VA (Vertical Alignment) system, or the like has been spread as a monitor used for various devices and is also used as a television by improving response performance. A liquid crystal display device has also been spread to the fields of portable information apparatuses such as cellular phone and digital camera. Although the portable information apparatus is mainly used personally, in recent years, the number of portable information apparatuses in which an inclination angle of a display unit can be varied has been increased and the display unit is often observed from the oblique direction. Therefore, a wide viewing angle is demanded.

Since the display for the portable information apparatus is used in a variety of environments in ranges from the outdoors in the fine weather to the darkroom, it is demanded that the display is transflective. In the transflective liquid crystal display device, a reflective display unit and a transmissive display unit are arranged in one pixel.

In this case, the reflective display unit performs a display by reflecting a light entering from the ambience with use of a reflective plate and a contrast ratio is kept constant irrespective of the ambient brightness, so that a good display state can be obtained under a relatively light environment in ranges from the outdoors in the fine weather to the interior of the room. According to the transmissive display unit, since a backlight is used and the brightness is kept constant irrespective of the environment, a display of a high contrast ratio can be obtained in a relatively dark environment in ranges from the interior of the room to the darkroom. According to the transflective liquid crystal display device having functions of both of them, a display of the high contrast ratio can be obtained in a wide range of environment from the outdoors in the fine weather to the darkroom.

Hitherto, it has been expected that the reflective display and the transmissive display of a wide viewing angle are simultaneously obtained by constructing the display of the IPS system known as a transmissive display of the wide viewing angle as a transflective type. The transflective IPS system has been disclosed in patent document 1.

In this liquid crystal display device of the transflective IPS system, although retardation plates are arranged on the entire upper and lower external surfaces of a liquid crystal panel which is produced by sealing a liquid crystal layer between two transparent substrates, the retardation plates have viewing angle dependency. Therefore, even if the phase differences among the liquid crystal layer and the plurality of retardation plates and an axis layout are optimized in a normal direction of the liquid crystal layer, as a viewing point gets away from the normal direction, conditions rapidly deteriorate to be away from optimum conditions for the dark display.

Although the viewing angle dependency of the retardation plates can be reduced by adjusting a refractive index in the thickness direction of the retardation plates, it cannot be completely eliminated. In the transflective IPS system, thus, an increase in dark display transmissive ratio in the viewing angle direction is large and viewing angle performance of the transmissive display is inferior to that of the transmissive IPS system.

Non-patent document 1 discloses the mounting structure and display characteristics in case where the retardation plates (retardation layer) are integrated into the panel, in place of the exteriorly mounted retardation plates.

According to patent document 2, in the VA system, retardation plates are arranged in close vicinity to the liquid crystal layer, patterned, and arranged only in the reflective display unit. However, nothing is considered with respect to application to the IPS system which provides the transmissive display with the wide viewing angle. One of the documents which disclose consideration for rendering the transflective IPS system having the inner retardation layer to have a wide viewing angle similar to that of the transmissive IPS system is patent document 3.

[Patent document 1] JP-A-11-242226

[Patent document 2] JP-A-2003-279957

[Patent document 3] JP-A-2005-338256

[Non-patent document 1] C. Doornkamp et al., Philips Research, “Next generation mobile LCDs with in-cell retarders.” International Display Workshops 2003, p 685 (2003)

### SUMMARY OF THE INVENTION

According to the transmissive IPS system, the liquid crystal layer has a homogeneous alignment, polarizers (upper and lower polarizers) placed on the outer surfaces of a first substrate and a second substrate are arranged so that their transmissive axes cross perpendicularly, and one of the transmissive axes is parallel with the alignment direction of the liquid crystal layer. Since the light entering the liquid crystal layer is linearly polarized light and its electric vector is parallel with the alignment direction of the liquid crystal layer, the phase differences are not obtained by the liquid crystal layer. Therefore, since a dark display of a low transmissive ratio can be realized and no retardation layer (retardation plates) exists between the liquid crystal layer and the polarizers, a surplus phase difference does not occur in the viewing angle direction and the dark display with the wide viewing angle can be realized. As mentioned above, the retardation layer (retardation plates) are inherently unnecessary in the transmissive IPS system.

The transflective liquid crystal display device includes the reflective display unit and the transmissive display portion on one pixel, in which the optical condition for the dark display is essentially different between the reflective display unit and the transmissive one. That is, in the reflective display unit, a ray of light is entered from the polarizer on the side of the substrate (first substrate) located on the top of a liquid crystal panel constituting the liquid crystal display device, reflected on the reflective plates inside the liquid crystal panel, passed through the polarizer located on the top thereof again, and then reaches the user. In contrast, in the transmissive display unit, a ray of light is entered from the polarizer on the side of the substrate (second substrate) located on the bottom of the liquid crystal panel, passed through the polarizer located on the top of the liquid crystal panel, and then reaches the user.

The phase difference between the phase of the light which provides the dark display in the reflective display unit and that in the transmissive display unit is caused due to such a difference between optical paths and it is equal to a quarter wave. Therefore, when the reflective display unit is in the light display mode, the transmissive display unit is in the dark display mode or vice versa, and the reflective display unit and the transmissive display unit have different applied voltage dependency. To allow those display units to have the same applied voltage dependency, the phase difference between the reflective display unit and the transmissive display unit has to be shifted by the quarter wave by some method.

According to the conventional transflective IPS system, the retardation plates are arranged on the entire (external) upper and lower surfaces of the liquid crystal panel. The light which enters the reflective display unit from the outside, the light reflected by the reflective plate of the reflective display unit, and the light which passed through the transmissive display unit pass through the retardation plates on the upper side (first substrate side) of the liquid crystal panel among those retardation plates. As mentioned above, the upper retardation plates act on both of the reflective display unit and the transmissive display unit. On the other hand, since only the light which is emitted from a light source and enters the transmissive display unit passes through the retardation plates on the lower side (second substrate side) of the liquid crystal panel, the lower retardation plates act only on the transmissive display unit. By using a difference between the actions of the upper retardation plates and the lower retardation plates onto the reflective display unit and the transmissive display unit, the phase difference between both of the display units is shifted by the quarter wave. However, since the surplus phase difference occurs in the viewing angle direction since the retardation plates exist between the liquid crystal layer and the polarizers, the viewing angle performance of the dark display deteriorates.

In such a transflective IPS system comprising a retardation layer which is produced by integrating the function of the retardation plates into the liquid crystal panel as disclosed in patent document 3, the retardation layer is formed only in the reflective display unit. For forming this retardation layer, patterning using the photolithography method, in which a retardation layer-forming material containing liquid crystal monomers with acrylates as main components is applied and subjected to photomask exposure, is employed.

The retardation layer-forming material contains a polymerization initiator which is likely to excessively react upon exposure. When the excessive reaction occurs, the pattern width of the cured retardation layer becomes much greater than the designed value and intrudes into the transmissive display unit, thereby lowering the transflective display characteristics. Such a material cannot cope with expected high-definition (640×480 pixels (VGA) in a display having a nominal diagonal dimension of 2 inches) displays. In addition, when the pattern width of the retardation layer becomes greater, the alignment tolerance of the substrates and the mask in exposure in the manufacturing steps is lowered.

The excessive reaction occurs because conventional materials for forming retardation layer are the special combinations of liquid crystal monomers and polymerization initiators only, and a radical consecutive reaction thus proceeds, which causes excessive curing upon exposure of the pattern.

An object of the invention is to provide a transflective liquid crystal display device which realizes a wide viewing angle similar to that in the transmissive IPS system by suppressing deterioration of the transflective display characteristics by forming the retardation layer so as to fall within the tolerance range of the designed pattern with respect to the reflective display unit.

According to the invention, retardation plates (retardation layer) are arranged only in a reflective display unit of the transflective IPS system and polarizers which are used for the reflective display unit and the transmissive display unit have common specifications. The polarizers are arranged entirely on the upper and lower surfaces of a first substrate and a second substrate which constitute the liquid crystal panel, and the retardation plates are inner retardation layers (at this time, it is desirable that the retardation layer is arranged on the interior displaying region side avoiding the portion where a sealing material and the above-mentioned first substrate oppose each other). The inner retardation layer is formed only in the reflective display unit. At this time, by arranging the upper and lower polarizers in a manner similar to that in the transmissive IPS system (their transmissive axes perpendicularly cross each other and one of them is parallel with a liquid crystal alignment direction), the same transmissive display viewing angle performance as that of the transmissive IPS system is realized.

After the polarizers are arranged in a manner similar to that in the transmissive IPS system, this inner retardation layer is arranged so as to shift a phase difference between the reflective display unit and the transmissive display unit by the quarter wave. Specifically speaking, a laminate of the liquid crystal layer and the inner retardation layer is arranged like a quarter wave plate of a wide band. That is, the retardation of one of them near the reflective plate is set to the quarter wave and that of the other is set to the half wave.

According to the IPS system, a layout of the liquid crystal layer is changed so that mainly a director azimuth is rotated in the layer when a voltage is applied, a change in tilt angle is small, and the retardation hardly changes. Therefore, between the liquid crystal layer and the retardation layer, the liquid crystal layer is arranged in close vicinity to a reflective electrode and its retardation is set to the quarter wave.

A slow axis of the inner retardation layer is determined as follows. An azimuth is defined counterclockwise by setting a transmissive axis of the upper polarizer to 0 degree. When a slow axis azimuth of the retardation layer is assumed to be θ_{PH} and an azimuth of the alignment direction of the liquid crystal layer is assumed to be θ_{LC}, an azimuth in the case of the quarter wave plate of the wide band is shown by the following expression (1).

2θ_{PH}=±45°+θ_{LC} (1)

where, θ_{LC} has to be set to either 0 degree or ±90 degrees since the layout of the polarizers in the transmissive display unit is similar to that of the transmissive IPS. Thus, θ_{PH} is equal to ±22.5 degrees (a range from 20 degrees or more to 25 degrees or less in consideration of an allowance of ±10% in manufacturing) or ±67.5 degrees (a range from 60 degrees or more to 75 degrees or less in consideration of an allowance of ±10% in manufacturing). By arranging the laminate of the liquid crystal layer and the inner retardation plates (retardation layer) like a quarter wave plate of the wide band, a reflective ratio of the whole visible wavelength region decreases and an achromatic reflection display of the small reflective ratio is obtained.

Between the reflective display unit and the transmissive display unit, the optimum values of the liquid crystal layer retardation to set the reflective ratio and the transmissive ratio to the maximum which is determined by light absorption of the polarizers are different. In the reflective display unit, the optimum value is set to the quarter wave. In the transmissive display unit, it is set to the half wave. To realize those values, a thickness of the liquid crystal layer of the reflective display unit has to be set to be smaller than that of the transmissive display unit. Specifically speaking, a thickness adjustment layer is arranged in the reflective display unit and the thickness of the liquid crystal layer of the reflective display unit is reduced by an amount corresponding to a thickness of the thickness adjustment layer. The thickness adjustment layer has to be arranged so as to correspond to the reflective display unit.

In the present invention, the retardation plates are mounted inside the panel in the form of the retardation layer. This inner retardation layer is arranged in a position corresponding to the reflective display unit. A difference between the retardation necessary for the reflective display unit and the transmissive display unit is equal to the quarter wave and the retardation necessary for the inner retardation layer is equal to the half wave.

Therefore, if a bireflingence of the inner retardation layer is equal to or more than two times of that of the liquid crystal layer, a thickness of the retardation layer is smaller than a difference between the liquid crystal layer thicknesses necessary for the reflective display unit and the transmissive display unit. In such a case, it is preferable that the retardation layer and the thickness adjustment layer are laminated and patterned so as to correspond to the reflective display unit, and a total of the layer thicknesses of both of them is set to the liquid crystal layer thickness difference necessary for the reflective display unit and the transmissive display unit.

If the bireflingence of the retardation layer is equal to two times of that of the liquid crystal layer, the thickness of the inner retardation layer is equal to the liquid crystal layer thickness difference necessary for the reflective display unit and the transmissive display unit. In this case, since the thickness adjustment layer is unnecessary, the manufacturing steps can be simplified.

As a retardation layer-forming material, one or more of triplet quenchers and radical quenchers (adsorbents or scavengers) are added to the liquid crystal monomers with acrylates.

According to the present invention, the display with high picture quality similar to that of a monitor can be carried. If it is used as a display of a cellular phone, image information of high picture quality can be reconstructed and the more advanced image information can be handled. Further, if it is used for a digital camera, an image before photographing and the photographed image can be easily confirmed. It is also presumed that a receiving state of a portable television will be remarkably improved in future in association with the spread of terrestrial digital broadcasting. If it is used for a portable television, the image information of high picture quality can be reproduced in any place.

According to the present invention, excessive curing of the retardation layer-forming material is suppressed, and a pattern reproducibility similar to a designed value can be realized. As a result, a liquid crystal panel having higher definition is achieved, and the alignment margin in pattern exposure in the manufacturing steps is also increased, thereby reducing faulty products resulting from misalignment.

The liquid crystal display device of the invention is a solidly structured all-environment type display device which can display in various environments ranging from the outdoors in the fine weather to the darkroom and, in the transmissive display, the display of a wide viewing angle similar to that of a monitor is obtained.

### BRIEF DESCRIPTION OF THE DRAWINGS

FIG. 1 is a plan view for illustrating a constitutional example of a pixel of a liquid crystal panel constituting Embodiment 1 of the liquid crystal display device according to the present invention;

FIG. 2 is a cross-sectional view of FIG. 1 taken along line A-A′ for illustrating a schematic constitutional example of a pixel of the liquid crystal panel shown in FIG. 1;

FIG. 3 is an explanatory drawing of the manufacturing process of a liquid crystal panel constituting the liquid crystal display device of Embodiment 1;

FIG. 4 is a graph in which the measurements of the light reaction rates of the retardation plate materials with or without a triplet quencher or a radical quencher added are shown and compared;

FIG. 5 is a specific explanatory drawing of the forming process of the retardation layer; and

FIG. 6 is a drawing for illustrating a wavelength at which coloration of the liquid crystal substance forming the retardation layer is caused.

### DETAILED DESCRIPTION

The best mode for carrying out the invention will be described below in detail with reference to the drawings by using Embodiments.

### Embodiment 1

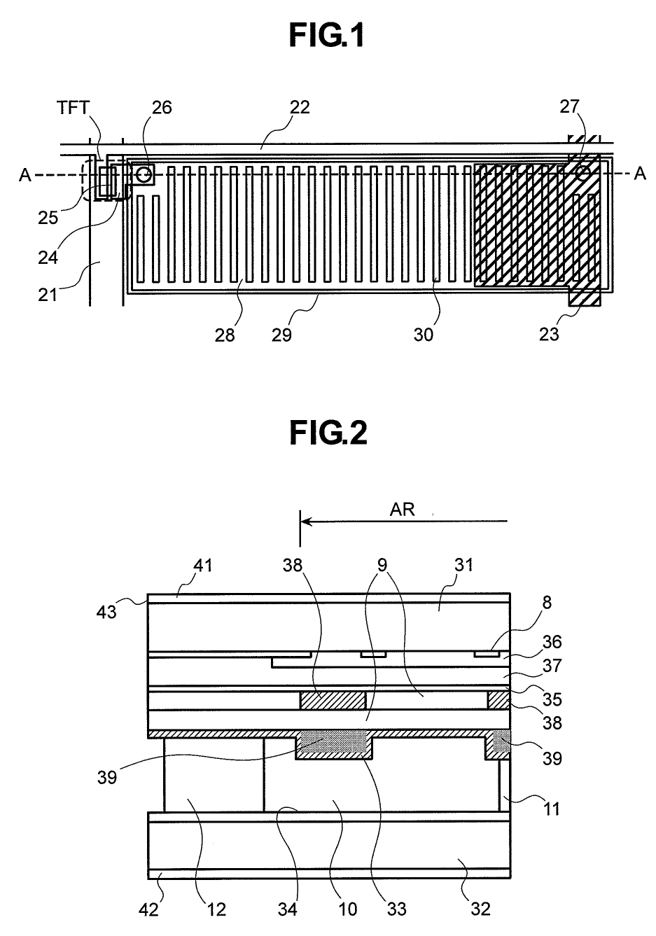

FIG. 1 is a plan view for illustrating a constitutional example of a pixel of a liquid crystal panel constituting Embodiment 1 of the liquid crystal display device according to the present invention. FIG. 2 is a cross-sectional view of FIG. 1 taken along line A-A′ for illustrating a schematic constitutional example of a pixel of the liquid crystal panel shown in FIG. 1. In FIG. 2, to simplify illustration, a thin film transistor, pixel electrode, common electrode and second polarizer which are provided on the second substrate are not shown. The liquid crystal panel of Embodiment 1 is constituted by a first substrate 31, a liquid crystal layer 10 and the second substrate 32, and the liquid crystal layer 10 is nipped in a gap between the first substrate 31 and second substrate 32 opposing each other. The first substrate 31 has, on its main face (inner face), a color filter 36 and a levelling layer (first protective film) 37 demarcated by a black matrix 8, a third alignment film (alignment film for inner retardation layer) 35, an inner retardation layer (hereinafter simply referred to as retardation layer) 38 and a first alignment film 33, which are laminated in the order stated.

The third alignment film 35 is provided with alignment controllability to control the alignment of a material for forming the retardation layer 38 including a liquid crystal layer composition. The first alignment film 33 is provided with alignment controllability to control the initial alignment of the liquid crystal layer 10 for controlling display light.

The second substrate 32 has, on its main face, a thin film transistor TFT for driving pixels. The thin film transistor TFT is connected to a scanning line 21, a signal line 22 and a pixel electrode 28. The thin film transistor TFT also has a common line 23 and a common electrode 29. Herein, thin film transistor TFT has a reverse staggered TFT structure, and its channel portion is formed of an amorphous silicon (a-Si) layer 25. The scanning line 21 and signal line 22 intersect in the row direction and in the column direction to form a two-dimensional matrix, and the thin film transistor TFT is positioned approximately at the intersection.

The common line 23 is arranged in parallel with the scanning line 21, and is connected to the common electrode 23 through a second through hole 27. The pixel electrode 28 and a source-drain electrode 24 of the thin film transistor TFT are connected through a first through hole 26. A second alignment film 34 is located on the pixel electrode 28, and is provided with alignment controllability to control the initial alignment of the liquid crystal layer 10.

The first substrate 31 in Embodiment 1 is suitably constituted of borosilicate-based glass having little ionic impurities, and its thickness is, for example, 0.5 mm. The color filters 36 demarcated by the black matrix 8 are repeatedly aligned in stripes that have portions (color subpixels) of red, green and blue, and each of the stripes is parallel with the signal electrode 22. The crenellation (or the unevenness) of the surface of the first substrate 31 on which the black matrix 8 and color filter 36 are formed is levelled by a levelling layer (first protective film, overcoat film) 37 made of a resin. The first alignment film 33 is a polyimide-based organic film, and is subjected to an alignment treatment by the rubbing method.

Borosilicate-based glass as used for the first substrate 31 is suitable for the second substrate 32, and its thickness is, for example, 0.5 mm. The second alignment film 34 is a polyimide-based organic film having the horizontal alignment performance, as well as the first alignment film 33. The signal line 22, scanning line 21 and common line 23 are formed of aluminium (Al), its alloy (alloy of aluminium and neodymium: Al—Nd), chromium (Cr) or the like. The pixel electrode 28 is desirably formed of a transparent conductive film of indium tin oxide and the like, and the common electrode 29 is also desirably formed of a transparent conductive film of ITO and the like.

The pixel electrode 28 has slits 30 which are parallel with the scanning line 21, and the pitch of the slits 30 is about 4 μm. The pixel electrode 28 and the common electrode 29 are separated by a third insulating layer having a thickness of 0.5 μm, and an electric field is formed between the pixel electrode 28 and common electrode 29 when a voltage is applied. The electric field is distorted into the shape of an arch by the influence of the third insulating layer and passes through the inside of the liquid crystal layer 10. Accordingly, a change in the alignment of the liquid crystal layer 10 occurs when a voltage is applied. The above-mentioned numerical values, including other numerical values in this specification and the drawings, are merely examples, and the present invention is not limited to these numerical values.

The common line 23 has such a structure that it overhangs into the pixel electrode 28 in a portion where it intersects with the pixel electrode 28. In FIG. 1, the portion where the common line 23 and the pixel electrode 28 are superposed is the reflective display unit, and the superposed portion of the pixel electrode 28 and the common electrode 29 other than this serves as a transmissive display unit as it passes the light of the backlight. Since the optimal thickness of the liquid crystal layer in the transmissive display unit and that in the reflective display unit are different, a step is produced in the boundary. To shorten the boundary of the transmissive display unit and the reflective display unit, the transmissive display unit and the reflective display unit are arranged in such a manner that the boundary is parallel with the shorter sides of the pixels.

If the lines such as the common line 23 and the like are used in common for the reflective plate, the effect of reducing the manufacturing steps is obtained. If the common line 23 is made of aluminum with high reflective ratio, a brighter reflection display is obtained. A similar effect can be obtained even if the common line 23 is made of chromium and the reflective plate made of aluminum or silver alloy is separately formed.

The liquid crystal layer 10 is a liquid crystal composition showing positive dielectric constant anisotropy in which a dielectric constant in the alignment direction is larger than that in its normal direction. Herein, its bireflingence is equal to 0.067 at 25° C. and the liquid crystal layer 10 exhibits a nematic phase in a temperature range including a room temperature region. For a holding period of time when the display is driven at a frequency of 60 Hz by using the thin film transistor, a high resistance value in which the sufficient reflective ratio and transmissive ratio are held and no flickers are caused is shown.

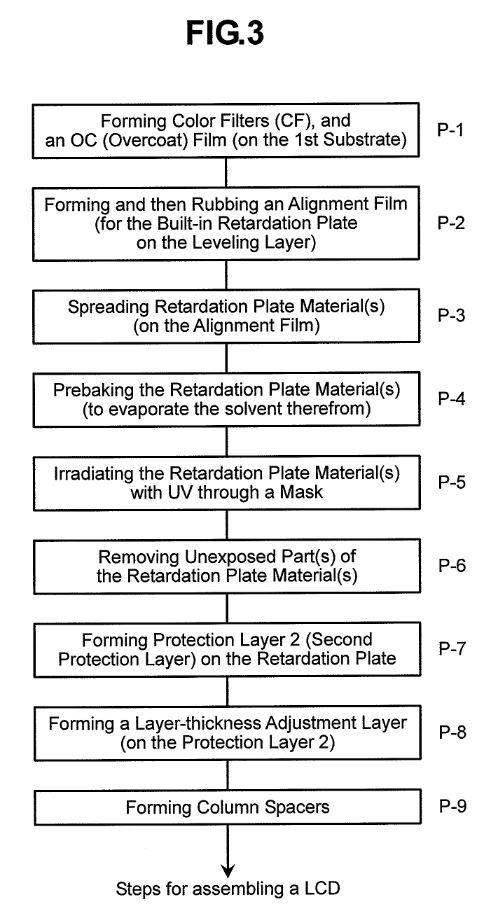

FIG. 3 is an explanatory chart of the manufacturing process of the liquid crystal panel constituting the liquid crystal display device of Embodiment 1. A seal portion is on the left side of the sheet of FIG. 3. In the seal portion of the main face of the first substrate 31, an extended portion (peripheral constituent portion) of the black matrix 8, the first protective film (levelling film) 37 of a transparent resin and a second protective film 9, which is also made of a transparent resin, are laminated. A sealing material 12 is interposed between the second protective film 9 and the second substrate 32 to seal the liquid crystal layer 10. The structure of the liquid crystal panel liquid crystal panel of FIG. 2 will be described with reference to the manufacturing process in FIG. 3.

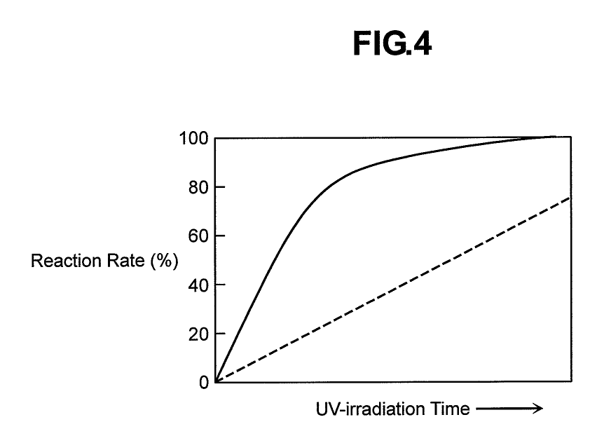

The black matrix 8 and the color filter 36 are formed on the main face of the first substrate, and their surfaces are covered with the first protective film 37 to level (process 1 in FIG. 4, hereinafter referred to as P-1). The alignment film 35 for retardation layer is applied onto this first protective film 37, and is rubbed to impart alignment controllability, which serves as the third alignment film (P-2).

The alignment film 35 for retardation layer is applied to a region surrounded by the displaying region and the region to which the sealing material is applied. More specifically, the alignment film 35 for retardation layer is applied in the manner of slightly protruding towards the side of the region to which the sealing material is applied beyond a displaying region AR, but not intruding the region where the sealing material is applied. The range that the film protrudes towards the side of the region to which the sealing material is applied is, for example, about 10% greater than the area of the displaying region AR. The third alignment film 35 has the horizontal alignment performance, and functions to determine the direction of the slow axis of the retardation layer 38.

A retardation plate-forming material prepared by adding one or more of triplet quenchers and radical quenchers (adsorbents or scavengers) containing a polymerization initiator (reaction initiator) to the liquid crystal monomers with acrylates is applied onto the third alignment film 35. Examples of liquid crystal monomers with acrylates are shown in “Chemical formula 1” and “Chemical formula 2”.

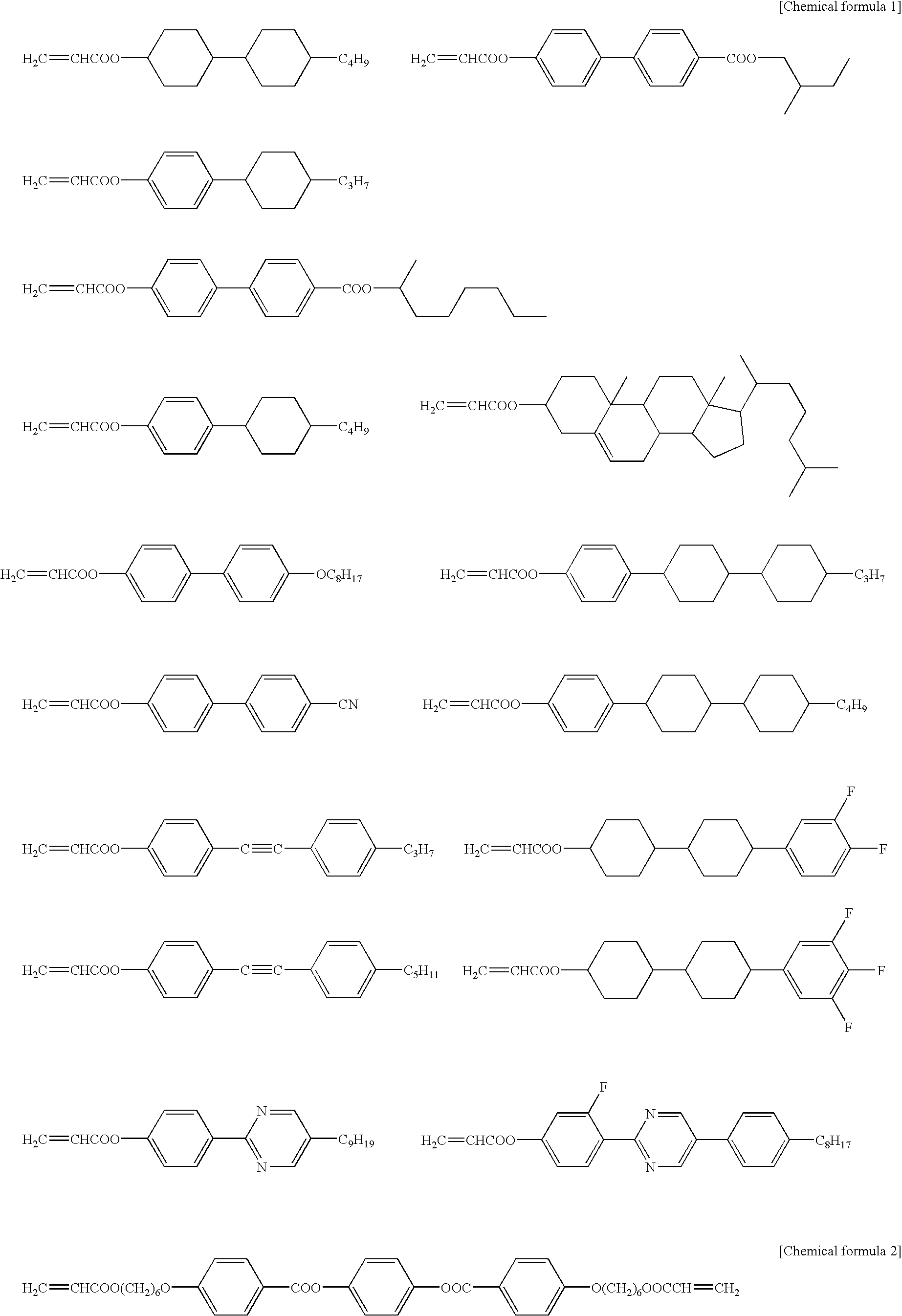

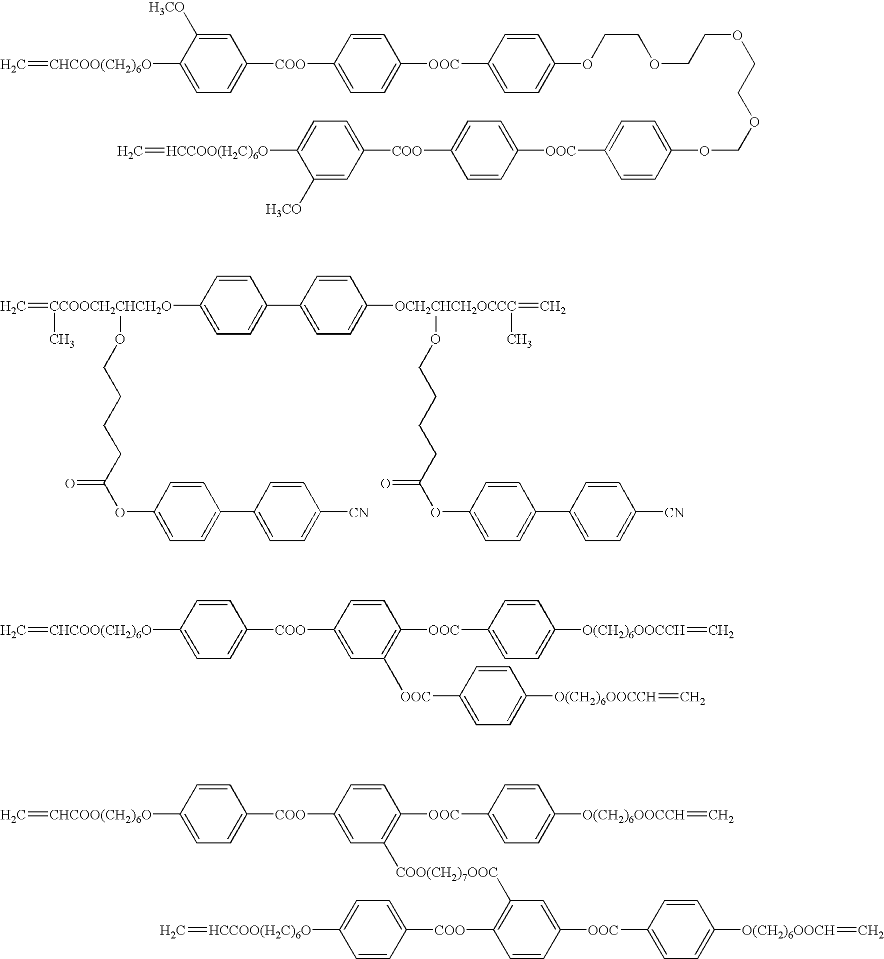

Herein, a retardation layer material comprising an organic material prepared by using a nematic liquid crystal layer having photoreactive acrylic groups (acrylates) at molecular terminals is used as a main component and dispersing a polymerization initiator in an organic solvent is applied (P-3).This is prebaked for 2 to 3 minutes by a hot plate at 100° C. or other heaters to remove the solvent (P-4), whereby a transparent film is formed. This film is aligned in the alignment treatment direction of the third alignment film 35 at the point when it is prebaked, and is imparted the function as a retardation layer.

The prebaked retardation layer material is irradiated with ultraviolet light at the portion corresponding to the reflective display unit by using an exposure mask having an opening corresponding to the pattern of the retardation layer to cause acrylic groups to undergo light polymerization and cure, giving the retardation layer 38 (P-5). This mask exposure allows acrylates corresponding to the opening of the exposure mask to cause polymerization, making a film which is insoluble in an organic solvent. At this time, the film thickness is adjusted by properly controlling a solution concentration and coating conditions upon coating, thereby setting the retardation of the retardation layer 38 to the half wave at a wavelength of 550 nm. Development by using an organic solvent is then carried out to remove unexposed portions (P-6).

Since the retardation layer 38 is made of a liquid crystal polymer, its alignment performance of the molecules is higher than that of the retardation plates formed by drawing an organic polymer film, and the layer 38 has the alignment performance similar to that of the liquid crystal layer 10. Therefore, Δn of the retardation layer 38 is much larger than that of the externally attached retardation plates, and can be set to a value which is almost equal to or larger than that of the liquid crystal layer 10 by properly adjusting the molecular structure and film forming conditions. Although a thickness of externally attached retardation plates is equal to tens of μm and is about ten times as that of the liquid crystal layer, the thickness of the retardation layer 38 can be greatly reduced by using the liquid crystal polymer to form an inner retardation layer and can be thinner than the step between the reflective display unit and the transmissive display unit. Thus, even if the retardation layer 38 is patterned in accordance with the reflective display unit, the special leveling is unnecessary.

A transparent organic layer is applied onto the retardation layer 38 to form a second protective layer (protective layer 2) 9. The second protective layer 9 covers the retardation layer 38 to form the layer on the entire first substrate 31 including the region where the sealing material 12 is applied (P-7).

A photosensitive organic material is applied in the manner of covering the second protective layer 9, and patterning is carried out by exposure and development so as to have a distribution similar to the reflective display unit (retardation layer portion), thereby forming a layer-thickness adjustment layer 39 (P-8).

If a layer whose Δn is larger than two times of that of the liquid crystal layer is used as the retardation layer 38, its thickness is insufficient when the retardation of the retardation layer 38 is set to the half wave. If the retardation layer 38 only is used, a difference of the retardation between the reflective display unit and the transmissive display unit is smaller than the quarter wave. By forming the layer-thickness adjustment layer 39 on the retardation layer 38, the retardation difference of the quarter wave between the reflective display unit and the transmissive display unit is ensured.

The first alignment film 33 is applied onto the uppermost layer of the main face of the first substrate 31, and the second alignment film 34 is applied onto the uppermost layer of the main face of the second substrate 32. The layers are subjected to a rubbing treatment in such a direction that they intersect with each other at a predetermined angle, and then a columnar spacer 11 is interposed in the displaying regions of the first substrate 31 and the second substrate 32 (P-8). Both substrates are stuck together by applying the sealing material 12 at the inside of their outer peripheries to assemble, and the liquid crystal layer 10 is sealed thereinside (steps for assembling a LCD).

Finally, a first polarizer 41 and a second polarizer 42 are arranged outside of the first substrate 31 and the second substrate 32. The first polarizer 41 and the second polarizer 42 are arranged so that the transmissive axis of the film 41 perpendicularly crosses the liquid crystal alignment direction and the transmissive axis of the film 42 is parallel with the liquid crystal alignment direction.

In Embodiment 1, an adhesive layer 43 having light diffusion performance in which a number of transparent micro spheres are mixed and whose refractive index differs from that of an adhesive material is used as the adhesive layer 43 of the first polarizer 41. Because of such a constitution, the first polarizer 41 has a function of enlarging an optical path of the incident light by using an effect of refraction which is caused since the refractive indices of both of them are different at an interface between the adhesive material and the micro spheres. Thus, iridescent coloring which is caused by interference of the reflected light in the pixel electrode 28 and the common electrode 29 can be reduced. However, it is needless to say that the constitution of the adhesive layer 43 is not limited to that mentioned above, and an adhesive material containing no micro spheres may be also used.

In the thus-manufactured transmissive display unit of the transflective liquid crystal panel of Embodiment 1, the transmissive axis of the first polarizer 41 perpendicularly crosses the transmissive axis of the second polarizer 42, and the latter is parallel with the liquid crystal alignment direction. Since such a construction is similar to that of the transmissive IPS system, as far as the transmissive display is concerned, a wide viewing angle which can also endure the application to the monitor is obtained in a manner similar to the transmissive IPS system.

Meanwhile, the reflective display unit is constructed by the liquid crystal layer 10 of homogeneous alignment, the retardation layer 38, and the first polarizer 41. The correlation among the slow axis of the inner retardation layer 38, the liquid crystal alignment direction, and the transmissive axis angle of the first polarizer 41 is as follow: since the slits 30 of the pixel electrode 28 shown in FIG. 1 are vertical to the signal line 22, the electric field direction is parallel with the signal line direction 22. When the azimuth is defined counterclockwise, the alignment direction of the liquid crystal layer is inclined by −75 degrees from the electric field direction. Thus, an effect in which the alignment change upon applying the voltage is stabilized and a threshold voltage at which the alignment change occurs is reduced is obtained. A slow axis direction of the retardation layer 38 is inclined by 67.5 degrees from the alignment direction of the liquid crystal layer and the transmissive axis of the first polarizer 41 is inclined by 90 degrees from the alignment direction of the liquid crystal layer.

In addition, since the retardation of the liquid crystal layer 10 of the reflective display unit is set to a quarter wave and that of the retardation layer 38 is set to the half wave, respectively, in the reflective display unit, the laminate of the liquid crystal layer 10, the retardation layer 38, and the first polarizer 41 becomes a circular polarizer of a wide band. When the voltage is not applied, the incident light becomes circularly polarized light or enters a polarizing state similar to it and enters the reflective plate in almost the whole region of a visible wavelength. After the reflection, when the light enters the first polarizer 41 again, their electric vectors become linearly polarized light which is parallel with the absorption axis of the first polarizer, so that the achromatic dark display is obtained.

The expression (1) to decide the slow axis azimuth of the retardation layer 38, the retardation of the retardation layer 38, and the retardation of the liquid crystal layer 10 are derived as follows by using a Poincare' sphere display. The Poincare' sphere display is defined in the space in which stokes parameters (S1, S2, S3) describing the polarizing state are set to three axes. Each point on the Poincare' sphere corresponds to the polarizing state in a one-to-one relational manner. For example, an intersection line (equator) with an (S1, S2) plane on the Poincare' sphere corresponds to the linearly polarized light. Crossing points (North Pole and South Pole) with the S3-axis correspond to the circularly polarized light. Others correspond to the elliptically polarized light. (S1, S2, S3) are expressed by the following expressions (2), (3), and (4) by using an arbitrary X-axial component Ex and an arbitrary Y-axial component Ey of an electric vector and a phase difference Δ between Ex and Ey, respectively.

S1=(Ex²−Ey²)/(Ex²+Ey²) (2)

S2=2ExEy cos δ/(Ex²+Ey²) (3)

S3=2ExEy sin δ/(Ex²+Ey²) (4)

A conversion of the polarizing state by the retardation layer or the liquid crystal layer without a twist is expressed as a rotation around a line which is included in the (S1, S2) plane on the Poincare' sphere and passes through the center of the Poincare' sphere. A rotational angle at this time is equal to ½ rotation if the retardation of the retardation plate is equal to the half wave and to ¼ rotation if it is equal to the quarter wave.

Attention is paid to a step in which the incident light of a representative wavelength in the visible light region, for example, a wavelength of 550 nm at which human luminosity is the highest sequentially passes through the first polarizer 41, the retardation layer 38, and the liquid crystal layer 10 of the reflective display unit and reaches the pixel electrode 28 or the common electrode 29.

For the sake of explanation, assuming that the Poincare' sphere is regarded as a globe, the crossing points with the S3-axis are called North Pole and South Pole, and the intersection line with the (S1, S2) plane is called an equator, incident light converted into linearly polarized light by the first polarizer 41 is located on the equator on the Poincare' sphere. However, it is rotated by ½ rotation around a rotation axis, as a rotational center by the retardation layer 38, moved to another point on the equator, and converted into linearly polarized light having a different electric vector. Subsequently, the light is rotated by ¼ rotation around a rotation axis, as a rotational center by the liquid crystal layer 10, moved to North Pole NP, and converted into circularly polarized light.

Subsequently, when attention is paid to the incident light of another wavelength, the retardation has wavelength dependency. In both the retardation layer and the liquid crystal layer, the shorter the wavelength is, the larger the retardation is, and the longer the wavelength is, the smaller the retardation is. Therefore, the rotational angle differs depending on the wavelength. In the rotation by the retardation layer 38, the light of a wavelength other than 550 nm is not rotated by ½ rotation but moved to a point out of the equator. Since the retardation of the blue light on the short wavelength side is larger than the half wave, the blue light is rotated by an angle larger than ½ rotation and moved to a position out of the equator. The retardation of the red light on the long wavelength side is smaller than the half wave, as shown in FIG. 7, the red light is rotated by an angle smaller than ½ rotation and moved to a position out of the equator.

However, in the rotation by the liquid crystal layer 10 which acts subsequently, since the moving direction becomes almost the opposite direction, a difference between the rotational angles due to the wavelength which is caused in the retardation layer 38 is compensated. That is, although the blue light on the short wavelength side is rotated by the angle larger than ¼ rotation even in the liquid crystal layer 10, since its movement is started from the Southern Hemisphere, the light reaches a position just on the North Pole. Although the red light on the long wavelength side is rotated by the angle smaller than ¼ rotation even in the liquid crystal layer 10, since its movement is started from the Northern Hemisphere, the light reaches a position just on the North Pole by rotating the light by the angle smaller than ¼ rotation. Thus, the light of each wavelength is concentrated on a position near the North Pole and becomes almost the same circularly polarized light. When observing it as a display state of the liquid crystal layer, the achromatic dark display whose reflective ratio is reduced in a wide region of the visible wavelength is obtained.

When an auxiliary line is drawn so as to extend the ¼ rotating direction, this auxiliary line perpendicularly crosses the liquid crystal layer alignment direction (azimuth θ′LC) indicative of the center of the rotation. The slow axis direction (azimuth θ′PH) of the inner retardation layer indicative of the center of the ½ rotation divides an angle between the S1-axis and the auxiliary line into two equal angles. The angle obtained by dividing the angle between the S1-axis and the auxiliary line into the two equal angles is equal to θ′PH−180°. Since θ′LC−180° is equal to (θ′PH−180°)×2+90°, the following expression (5) is obtained.

2θ′PH=90°+θ′LC (5)

Although the incident light of each wavelength is concentrated on the North Pole NP on the Poincare' sphere mentioned above, a similar effect can be obtained even if they are concentrated on South Pole SP on the Poincare' sphere. In this case, the relation between θ′PH and θ′LC is expressed by the following expression (6).

2θ′PH=−90+θ′LC (6)

Further, as another method of concentrating the incident light of each wavelength on the North Pole NP or the South Pole SP, the relation between θ′PH and θ′LC is expressed by the expressions (5) and (6), respectively. That is, since 360°−θ′LC is equal to (360°−θ′PH)×2+90°, 2θ′PH=360°+90°+θ′LC and it is expressed by the expression (5). Since 180°−θ′LC is equal to (180°−θ′PH)×2+90°, 2θ′PH=360°−90°+θ′LC and it is expressed by the expression (6).

The rotation axis on the Poincare' sphere corresponds to the azimuths θPH and θLC of the slow axis and the azimuths of the rotation axis are two times (θ′PH=2θPH, θ′LC=2′LC) of the azimuths of the slow axis in a real space. By substituting them into the expressions (5) and (6), the above-mentioned expression (1) showing the relation between the slow axis azimuths of the inner retardation layer and the liquid crystal layer is obtained.

In Embodiment 1, to equalize the viewing angle performance of the transmissive display to that of the transmissive IPS, the layout of the polarizers in the transmissive display unit is set to be similar to that of the transmissive IPS system. For this purpose, θLC=90 degrees. By substituting it into the expression (1) and selecting a minus sign, θPH=22.5 degrees and the slow axis azimuth of the retardation layer is obtained. Incidentally, how to set the slow axis azimuth of the retardation layer is detailed in Patent document 3, so more explanation about this will be omitted.

The transflective liquid crystal panel manufactured as mentioned above is connected to a driving apparatus, a backlight is arranged on the rear side of the panel to constitute a liquid crystal display device, and the display state is observed. When observing the display state in the light place in the state where the backlight has been lit off, a display image according to the reflective display can be confirmed. Subsequently, when observing the display state in the dark place in the state where the backlight has been lit on, a display image according to the transmissive display can be confirmed. Even if the observing direction from the normal of the substrate is changed in a wide range, gradation inversion does not occur and a reduction in contrast ratio is small.

Since there lies no retardation layer material whose adhesive strength with the sealing material is low between the sealing material 12 and the first substrate 31, the first substrate 31 and the second substrate 32 are strongly stuck, whereby a shift and peeling of the two substrates caused by the application of external force are avoided, obtaining a solidly structured all-environment type display device.

### Embodiment 2

Embodiment 2 has a construction similar to FIG. 1 except that the third alignment film 35 in Embodiment 1 is formed on the entire first substrate 31 including the seal area, and therefore no repeated explanation will be provided.

Examples of photopolymerization initiators contained in conventional retardation layer-forming materials include IRUGACURE® 907, IRUGACURE 369, IRUGACURE 819, IRUGACURE 127, DAROCUR® TPO, IRUGACURE OXE01, 2-(3,4-methylenedioxyphenyl)-4, and 6-bis(trichloromethyl)-1,3,5-triazine manufactured by Ciba Specialty Chemicals, among others. Examples of photopolymerization initiators are shown in “Chemical formula 3”.

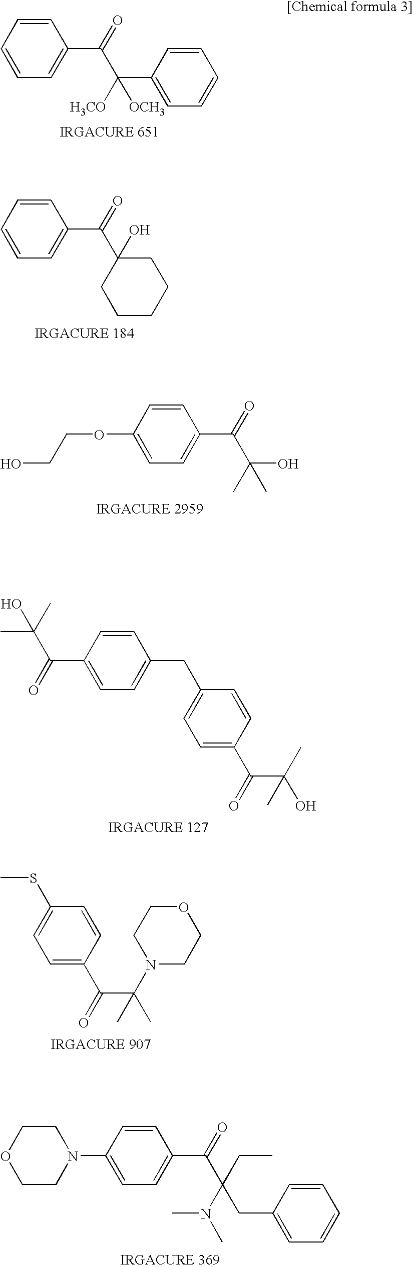

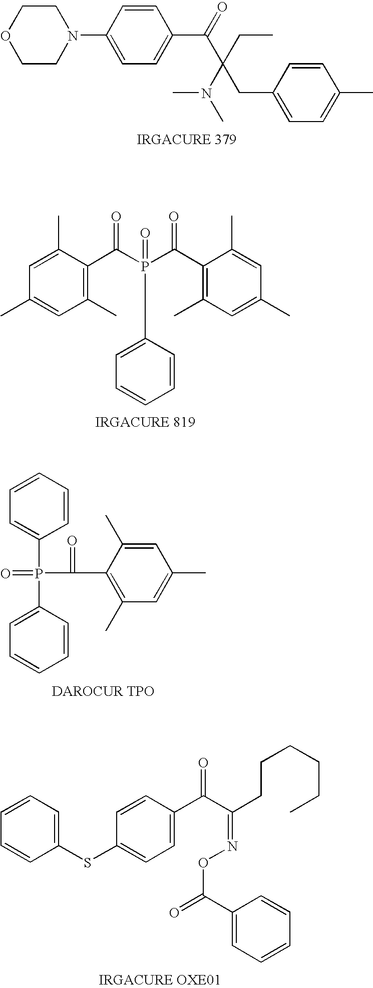

When a photopolymerization initiator selected from the above is added, the polymerization speed is high, and the degree of polymerization is presumed to be high. Therefore, the pattern undergoes excessive curing exceeding the width (size) of the mask opening in pattern exposure, and the pattern width after development becomes about 10 to 15 μm wider than the width of the mask opening.

If the width of the pattern of the retardation layer is large, the alignment tolerance of the substrates and the photomask in the later manufacturing steps is lowered, thereby lowering accuracy.

In Embodiments of the present invention, as a solution for this, a photopolymerization initiator is added to the retardation plate material, and a triplet quencher or radical quencher (adsorbent or scavenger) is also added. The amount of the radical quencher added is about 0.5 to 3% of the total amount of the retardation plate material.

FIG. 4 is a graph in which the measurements of the light reaction rates of the retardation plate materials with or without a triplet quencher or a radical quencher added are shown and compared. In FIG. 4, the solid line represents the reaction rate (%) for the UV-irradiation time of the retardation plate material containing only a photopolymerization initiator, while the broken line represents the reaction rate (%) for the UV-irradiation time of the retardation plate material containing a photopolymerization initiator and a triplet quencher, or a radical quencher.

In this measurement, the retardation plate materials having respective compositions were measured by the differential calorimetry (Photo DSC method) with UV irradiation to determine the polymerization rates (reaction speeds) and degrees of polymerization (reaction rates) of the materials. As shown in FIG. 4, the retardation plate material containing only a photopolymerization initiator shows a high reaction rate of polymerization from the early stage of UV irradiation. In contrast, the retardation plate material containing a photopolymerization initiator and a triplet quencher, or a radical quencher shows a lower degree of polymerization or an inhibited consecutive reaction. It is therefore observed that it polymerizes at an approximately constant reaction rate with respect to UV-irradiation time.

As a triplet quencher added to the retardation plate material, azulene, anthracene and ferrocene can be used singly or in combination of two or more kinds. As a radical quencher (adsorbent or scavenger), hydroquinone, phenothiazine, hydroquinone monomethyl ether, methyl hydroquinone, p-benzoquinone, methyl-p-benzoquinone, 2,5 diphenyl-P-benzoquinone, 2-ethylanthraquinone, 5,5 dimethyl-1-pyrroline-N-oxide and butylhydroxyanisol can be used singly or in combination of two or more kinds.

Accordingly, the width of the pattern of the retardation layer is suppressed to a value which is about 3 to 5 μm larger than the designed value of the width of the mask opening, which improves the reproducibility of the photomask and achieves higher definition of the liquid crystal panel. In addition, the tolerance of positioning accuracy in pattern exposure in the manufacturing steps is increased, and faulty products resulting from mispositioning of the mask in exposure are thus reduced.

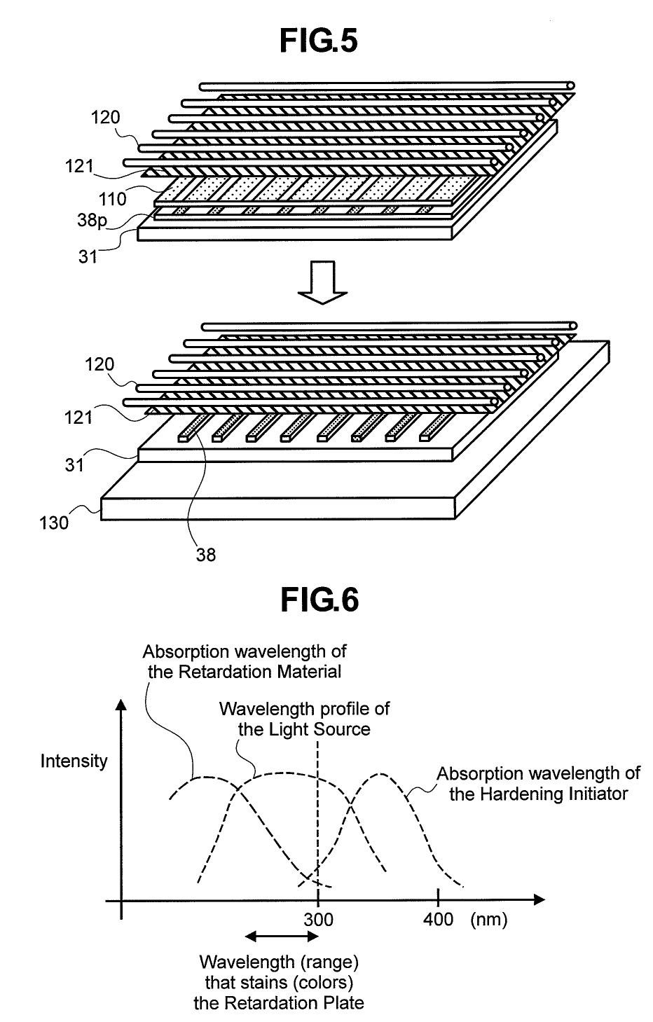

Subsequently, the forming process of the retardation layer in Embodiments of the present invention will be further described. FIG. 5 is a drawing for specifically explaining forming of the retardation layer. A retardation layer material 38p is prepared by dissolving liquid crystal monomers with acrylates, a photopolymerization initiator and a triplet quencher or a radical quencher in an organic solvent.

To begin with, the retardation layer material 38p is applied to the inside of the seal area by the screen printing, and the material is baked at about 100° C. for 2 to 5 minutes by using a hot plate or the like to remove a solvent in the film, thereby forming a transparent film. At this point, the retardation layer material 38p is aligned by the alignment controllability of the third alignment film 35 located therebelow.

A mask 110 in which an opening is provided in such a manner that only the portion corresponding to the reflective display unit of the material 38p for forming the retardation layer is irradiated with light is arranged on the first substrate 31 with the material 38p for forming the retardation layer applied thereon, and the material is exposed to the light of a lamp 120. The exposure quantity is about 50 to 200 mJ/cm². In such a manner, only the acrylates in the portion of the retardation layer material 38p corresponding to the opening in the mask 110 are polymerized and cured.

The lamp 120 may be UV fluorescent lamps of about 20 W arranged in parallel. A type of such lamps, black-light blue (BL-B) fluorescent lamps are desirably used. Black-light blue fluorescent lamps mainly emit near-ultraviolet lights (nominal wavelength range: 300 to 400 nm). For example, they show a peak wavelength of 360 nm. It is desirable to provide a UV filter 121 between the lamp 120 and the first substrate 31 to block short-wavelength lights. Subsequently, the material is developed with an organic solvent to remove the unexposed portions.

Subsequently, the materials for forming the retardation layer, the wavelength of an irradiated light and a photopolymerization initiator for use in the present invention will be described. Herein, coloration of the retardation layer 38 can be inhibited by appropriately selecting these.

FIG. 6 is a drawing for illustrating a wavelength at which coloration of the liquid crystal substance which forms the retardation layer occurs. The liquid crystal substance for forming the retardation layer normally undergoes coloration when it absorbs light at a wavelength shorter than 300 nm. Therefore, it is necessary to prevent irradiation of a light of a wavelength shorter than 300 nm.

For this reason, a lamp which can irradiate a light of a specific wavelength is used. For example, a lamp having high intensity in a wavelength longer than 300 nm and having low intensity in a wavelength shorter than 300 nm is used. Alternatively, a filter which blocks a light of a wavelength shorter than 300 nm may be used. For example, a short-wavelength cut UV filter which blocks short-wavelength lights and the like can be used. A filter which cuts all the absorption wavelengths of the liquid crystal substance for forming the retardation plate may be also used. For example, Teijin Tetron film G2 (product name) manufactured by TEIJIN DUPONT FILMS JAPAN LTD. can be used.

As described above, since lights of 300 nm or longer are irradiated by selecting the lamp and filter, the material 38p of the retardation layer needs to be cured by irradiation of a light of a wavelength of 300 nm or longer. Thus, a photopolymerization initiator having an absorption at 300 to 400 nm is selected. Preferably, it is a photopolymerization initiator having an extinction coefficient in a solvent, methanol, ranging from 1000 ml/gcm or more at 365 nm to 100 ml/gcm or more at 405 nm.

As the materials for forming the retardation plate, liquid crystal monomers with acrylates as shown in [Chemical formula 1] and [Chemical formula 2] mentioned above can be used.

As the photopolymerization initiator, among those mentioned above, IRUGACURE 819 has resistance to coloration and low volatility, and thus requires less exposure quantity.

As mentioned above, the material of the retardation plate, the wavelength of the irradiated light and photopolymerization initiator are suitably selected, whereby the transmission coefficients of the retardation layer 38 and a residual layer 38n can be set to be 90% or more of that of a visible light (for example, a light of a wavelength ranging from 400 nm to 800 nm), and coloration of these can be inhibited.

After the formation of the retardation layer 38, a protective film (insulating film) 9 is formed on the entire main face of the first substrate 31 (inner retardation plate 38) formed on the main face. The protective film 9 is formed of, for example, the same material as the levelling layer mentioned above or a transparent material containing no light initiator. A resist layer for forming the layer-thickness adjustment layer 39 is formed on the upper face of this protective film 9, and then the first alignment film 33 for aligning the liquid crystal layer 10 is formed. It is also possible to form the levelling layer to level the base layer before the first alignment film 33 is formed, and then form the first alignment film 33 on the levelling layer.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. A liquid crystal display device comprising
a first substrate,
a second substrate,
a liquid crystal layer arranged between said first and second substrates,
a first alignment film provided between said liquid crystal layer and said first substrate,
a second alignment film provided between said liquid crystal layer and said second substrate,
a pixel electrode and a common electrode provided for each pixel on a main face of said second substrate,
a reflective display unit and a transmissive display unit provided for said each pixel,
a retardation layer provided in a portion corresponding to said reflective display unit on the main face of said second substrate,
a sealing material for sealing said liquid crystal layer provided between the peripheries of said first substrate and said second substrate in a manner of surrounding the substrates,
a first polarizer placed on the outer surface of said first substrate, and
a second polarizer placed on the outer surface of said second substrate, wherein:
a material for forming said retardation layer is a liquid crystal monomer with acrylates containing a polymerization initiator and one or more members selected from a triplet quencher and a radical quencher added thereto, and
an electric field which is approximately parallel with the substrate face of said second substrate is applied between said pixel electrode and said common electrode to drive the liquid crystal layer.

2. A liquid crystal display device according to claim 1, wherein
said retardation layer is arranged between said first polarizer and the liquid crystal layer.

3. A liquid crystal display device according to claim 1, wherein
the transmissive axes of said first polarizer and said second polarizer are arranged in the manner of perpendicularly crossing each other.

4. A liquid crystal display device according to claim 3, wherein
either one of the transmissive axes of said first polarizer and said second polarizer is arranged in parallel with the alignment direction of said liquid crystal layer.

5. A liquid crystal display device according to claim 1, wherein
the retardation of said liquid crystal layer of said reflective display unit is a quarter wave, and
the retardation of said retardation plate is a half wave.

6. A liquid crystal display device according to claim 1, wherein
said liquid crystal layer has a homogeneous alignment, the transmissive axis of said first polarizer is parallel with the alignment direction of said liquid crystal layer, and
an angle between a slow axis azimuth of the retardation plate and the transmissive axis of the first polarizer lies within a range from 20° or more to 25° or less or a range from 60° or more to 75° or less.

7. A liquid crystal display device according to claim 1, wherein
a layer-thickness adjustment layer is provided above said retardation layer.

8. A liquid crystal display device according to claim 7, wherein
a protective film which covers said retardation layer and is made of a transparent resin is provided below said layer-thickness adjustment layer.

9. A liquid crystal display device according to claim 1, wherein
an alignment film which restricts the initial alignment of the liquid crystal layer is provided at the boundary of said liquid crystal layer.

10. A liquid crystal display device according to claim 1, wherein
said retardation layer is provided in a portion avoiding the portion where said sealing material and said first substrate oppose each other.

11. A method of manufacturing a liquid crystal display device in which a liquid crystal layer is nipped in a gap across which the first substrate and second substrate oppose each other, said first substrate and said second substrate are sealed at the outer peripheries of their display regions with a sealing material, said displaying region is constituted by a plurality of pixels which are arranged in a matrix array, and each of said pixels is provided with a reflective display unit and a transmissive display unit,
the method comprising the steps of forming an alignment film for retardation layer on the main face of said first substrate, and imparting alignment controllability to the alignment film for retardation layer,
a retardation layer material application step in which a nematic liquid crystal monomer with acrylates having light curability containing a polymerization initiator and one or more members selected from a triplet quencher and a radical quencher added thereto in the manner of covering said alignment film for retardation layer is applied as a retardation layer material,
an exposure step in which a portion of said retardation layer material corresponding to said reflective display unit is selectively exposed and cured, and
a step of removing an unexposed portion in which a portion of said retardation layer material corresponding to said reflective display unit is removed.

12. A liquid crystal display device according to claim 11, wherein
a step of forming a layer-thickness adjustment layer above said retardation layer is included.

13. A liquid crystal display device according to claim 12, wherein
a step of covering said retardation layer and a residual layer of its forming material, and forming a protective film made of a transparent resin below said layer-thickness adjustment layer is included.
